(19) United States
(12) Patent Application Publication
(10) Pub. No.: US 2026/0190162 A1
(43) Pub. Date: Jul. 2, 2026

(54) PREDICTING INITIAL ACCESS FAILURE USING PREAMBLE CHARACTERISTICS

(71) Applicant: TELEFONAKTIEBOLAGET LM ERICSSON (PUBL), Stockholm (SE)

(72) Inventors: Zaigham Kazmi, Austin, TX (US); Swathi Priya Dhandapani, Austin, TX (US); Emre Gonultas, Austin, TX (US)

(21) Appl. No.: 19/130,724

(22) PCT Filed: Dec. 2, 2022
(86) PCT No.: PCT/IB2022/061731

§ 371 Date: May 16, 2025

(51) Int. Cl. H04W 74/08; H04L 41/16; H04W 74/0833

(52) U.S. Cl. CPC H04W 74/0866; H04L 41/16; H04W 74/0833

(57) ABSTRACT

Methods and systems are described for the performance of initial access procedures in a communication network. A network node can analyze characteristics of a first message and preamble received from a user equipment (UE). The characteristics analyzed or measured can include timing advance characteristics, beam index characteristics, preamble power characteristics, a portion of the first message, a measurement related to the first message, or other characteristics. The network node can then use an artificial intelligence or machine learning model to estimate a probability that a third message will be received from the UE. If the probability is high enough, then the network node responds to the first message with a second message. If the probability is too low, then the network node will not reply.

### TECHNICAL FIELD

The present disclosure generally relates to the technical field of wireless communications and more particularly to initial access attempts.

### BACKGROUND

In typical cellular networks, a user equipment (UE) connects to the network (e.g., a Radio Access Network (RAN)) by performing a random-access procedure. More specifically, any UEs that desire to connect to the network must initially connect by sending a signal called preamble (e.g., MSG1). The network then typically responds with a Random-Access Response (RAR) (e.g., MSG2) and expects UE to acknowledge reception of the RAR with another signal (e.g., MSG3). The contents of the third message may depend on the type of access the UE is trying to obtain as well as other factors. However, in most cases, the reception of the third message concludes the initial access procedure.

In practice, a high number of initial access attempts fail mostly because the network does not receive a third message acknowledging reception of the RAR. For example, it is estimated that somewhere between 70-90% of initial access attempts fail due to the network failing to receive the acknowledgement (e.g., MSG3) after it transmitted the RAR (e.g., the second message). This failure results in a huge waste of downlink and uplink resources.

In general, the failure could be for any number of following reasons. For example, when decoding the preamble, it could be determined that the preamble was not a real preamble, but rather just the energy in the system being falsely decoded as a preamble. This style of failure is often referred to as a “fake preamble.” In another example, the UE may never receive the second message due to a bad downlink channel condition. Similarly, in some cases, the network may not be able to successfully decode the third message due to a bad uplink channel condition.

Given the multiplicity of reasons for failures, it can be hard to determine if a network would receive the third message or not if it responds to the preamble. Moreover, there is no existing technology to predict success of initial access by a radio node (network) based on received preamble characteristics. Thus, a solution is needed that can predict the success or failure of an initial access attempt earlier in the process.

Current approaches regarding initial access procedures involve using a UE to adapt its Random-Access parameters based on an Artificial Intelligence (AI) or Machine Learning (ML) model provided by the network. More specifically, the AI/ML model is provided to the UE by the network. The input parameters for the AI/ML model mostly consists of configuration parameters (e.g., Cell ID, RACH power configuration, etc.) and some measured values (e.g., interference, neighbor cell measurement, etc.) The preamble is then transmitted to the UE, which is configured to evaluate the preamble based the output of said AI/ML model. Accordingly, the AI/ML model in this case predicts the success of random access (i.e., change of a successful reception of preamble (e.g., MSG1). Further details can be found in International Publication Number WO2022/122997 A1, entitled “Predicting Random Access Procedure Performance Based on AI/ML Models,” International Publication Number WO2021/215995 A9, entitled, “Improving Random Access Based on Artificial Intelligence/Machine Learning (AI/ML).” Another current approach attempts to control the threshold value used to detect preamble (random access) for congestion control purpose, but without making any prediction about the success of initial access (as seen in Japan Application No. 2018019376A, entitled, “Radio Communication System, Base Station, and Threshold Value Control System”).

### SUMMARY

One embodiment under the present disclosure comprises a method performed by a UE for performing an initial access procedure. The method comprises sending a first message comprising a preamble to a network node, wherein the network node is configured to estimate, using an AI model and the preamble, a probability that a third message will be received from the UE, and to send to the UE a second message if the probability exceeds a minimum threshold.

Another embodiment comprises a method performed by a network node for performing an initial access procedure. The method comprises receiving, from a UE, a first message comprising a preamble; estimating, using an AI model, a probability that a third message will be received from the UE based on the preamble; and responsive to estimating the probability exceeds a minimum threshold, transmitting, to the UE, a second message.

A further embodiment comprises a computer implemented method for performing an initial access procedure. The method comprises receiving, from a UE, a first message comprising a preamble; estimating, using an AI model, a probability that a third message will be successfully received from the UE based on the preamble; and responsive to estimating the probability exceeds a minimum threshold, transmitting, to the UE, a second message.

A further embodiment comprises a UE for performing an initial access procedure. The UE comprises processing circuitry configured to perform any of the steps of any UE-based methods described herein; and power supply circuitry configured to supply power to the processing circuitry.

A further embodiment comprises a network node for performing an initial access procedure. The network node comprises processing circuitry configured to perform any of the steps of any network node-based methods described herein; and power supply circuitry configured to supply power to the processing circuitry.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 shows a schematic of a process flow embodiment under the present disclosure;

FIG. 2 shows a schematic of a process flow embodiment under the present disclosure;

FIG. 3 shows a schematic of a process flow embodiment under the present disclosure;

FIG. 4 shows schematic of an example neural network under the present disclosure;

FIG. 5 shows a schematic of a process flow embodiment under the present disclosure;

FIG. 6 shows a schematic of a communication system embodiment under the present disclosure;

FIG. 7 shows a schematic of a user equipment embodiment under the present disclosure;

FIG. 8 shows a schematic of a network node embodiment under the present disclosure;

FIG. 9 shows a schematic of a host embodiment under the present disclosure;

FIG. 10 shows a schematic of a virtualization environment embodiment under the present disclosure; and

FIG. 11 shows a schematic representation of an embodiment of communication amongst nodes, hosts, and user equipment under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

### System Overview

As discussed herein, an initial access procedure involves a UE and a network (e.g., network node) exchanging specific data in a specific order and establishing a connection. Thus, solely to improve readability and understanding, the sending and receiving of will be referred to herein as “a message,” and the sequenced order of those messages will be identified numerically. Accordingly, the initial access preamble from the UE to the network will be referenced herein as “MSG1,” while the RAR message from the network to the UE will be referenced herein as “MSG2,” and the acknowledgement message from the UE to the network will be referenced herein as “MSG3.”

Thus, in order to overcome the existing technology shortcomings (e.g., predicting the success or failure of an initial accesses attempt based on the preamble), described herein are systems and methods that generate a function that can map the initial access preamble (i.e., MSG1) characteristics (e.g., timing advance, beam index, preamble power, etc.) to an acknowledge reception of RAR outcome prediction (e.g., an outcome prediction of Acknowledgement (ACK) or Negative Acknowledgement (NACK)). In some implementations, generating this function may consist of performing a supervised learning process (e.g., using deep neural networks) to learn the acknowledge reception of RAR from the extractable preamble characteristics or features (e.g., timing advance, beam index, and preamble power). Once this learning process is completed, the function parameters may be used to predict the likelihood of successfully decoding MSG3. Based on this predicted “likelihood of success,” a cellular network can decide whether to schedule MSG2 for a given random access request.

Stated differently, the systems and methods disclosed herein enable a network, or network node to determine, based solely on the preamble, which preambles, and by extension, which UE devices, are not expected to result in successful initial access. The network can then discard these preambles instead of responding with MSG2, thus saving both downlink and uplink radio resources. Accordingly, as will be discussed in further detail herein, in some implementations, the systems and methods may utilize a machine learning algorithm to predict, based on the characteristics of preamble, what the likelihood is of a network successfully decoding msessage3. By way of non-limiting example, the AI/ML models discussed herein may use characteristic parameters associated with the received preamble, including, but not limited to received power, beam in which preamble was received, and the like.

The benefits of the various implementations discussed herein include, but are not limited to: (1) does not require updates to any standards, (2) does not require additional signaling (e.g., neither between the network (e.g., RAN) and the UE, nor within the network), (3) saves downlink and uplink radio resources, (4) improves initial access Key Performance Indicators (KPI) by reducing number of failed initial access attempts, and (5) improved latency of initial access due to discarding preambles earlier in the process. Although it is possible for the system to generate a “False Negative” (i.e., incorrectly determining that the network would not successfully decode MSG3), the effect, as tested, is very minor (e.g., 1-4%). Moreover, not only is the percent of false negatives low (e.g., 1-4%), but also, the UEs that are discarded will repeat the attempt again with increased preamble power. The increase in preamble power should then result in a change in the preamble characteristics and thus an increase in the calculated likelihood that the preamble will be successfully decoded. Thus, in typical practice, the chances of a specific UE being denied service is nearly impossible.

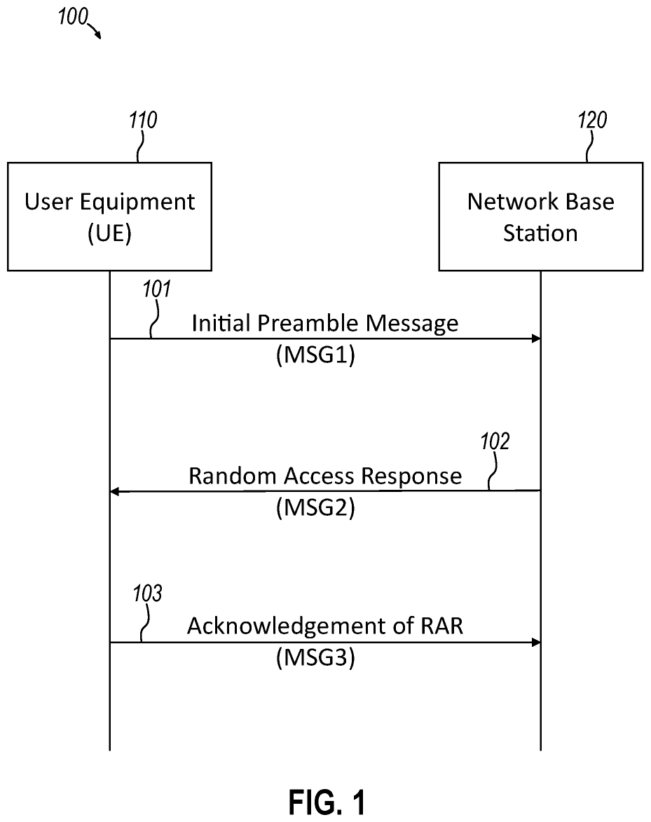

Referring now to FIG. 1, an illustrative diagram of an initial access procedure 100 is shown. Although not shown, some implementations, may include a step in which the UE searches for one or more Synchronization Signals on the broadcast channel. In a further implementation, two types of synchronization signals may be used, defined as a Primary Synchronization Signal (PSS) and/or the Secondary Synchronization Signal (SSS). Upon successful synchronization, the UE may receive, or obtain, system information that provides a Random-Access Channel (RACH) configuration. Another factor that may be involved in the synchronization process is whether the network is a Stand Alone (SA) network or a Not Stand Alone (NSA) network. For an NSA, the system information is generally provided by the master node, or primary cell, whereas for a SA cell, the system information may be provided via System Information Block-1 (SIB1) and broadcasted to all UEs.

Once synchronization is complete, the UE 110 may initiate an access attempt to the network base station 120, as Random Access, by sending a preamble 101, referred to as MSG1. In some implementations, particularly in a 5G implementation, UE 110 may select a transmission slot for preamble message 101 based on the beam in which it decoded the synchronization signal (not shown). The UE may also start monitoring the downlink (DL) channel to see if the base station 120 (e.g., a gNodeB) answers the request to connect to the network. If the base station 120 does not answer the request, the UE 110 may make a new attempt with the increased power (not shown).

Once the base station 120 receives the preamble (i.e., MSG1) 101 it may attempt to decode it. Upon successful decoding of the preamble message 101, the base station 120 may obtain, based on the decoding, the preamble power, timing offset, and beam associated with the preamble. Based on these factors, the base station 120 may be able to estimate the distance between the base station and the UE 110. In a 5G implementation, the base station 120 may also determine which beam (e.g., in the form of a beam index) was used by the UE 110 to receive the system information based on the slot in which UE transmitted the preamble 101. Once the preamble message 101 is received and decoded, the base station 120 may transmit a Random-Access Response 102 indicating the reception of the preamble message and providing a time-alignment command adjusting the transmission timing of the device based on the timing of the received preamble.

Once the RAR message (i.e., MSG2) 102 is sent from the base station 120 to the UE 110, the UE decodes MSG2 and responds to the base station with an Acknowledgement (ACK) of the RAR 103. However, as discussed herein, in some implementations, the UE 110 may instead transmit a Negative Acknowledgement (NACK) or a Discontinuous Transmission (DTX) message (now shown). Assuming the UE 110 sent an acknowledgement of the RAR 103, and not a NACK or DTX, the base station 120 can then assume that both MSG2 102 and MSG3 103 succeeded. Once the base station 120 confirms MSG2 102 and MSG3 103 were successful, the UE 110 and base station may exchange uplink and downlink messages (not shown), with the aim of resolving any potential collisions due to simultaneous transmissions of the same preamble from multiple devices (e.g., UEs) within the cell. If successful, the UE 110 is transferred to a “connected state” with the base station 120.

As discussed herein, in some implementations, the base station 120 may provide system information to the UE 110 which instructs the UE on how and when to transmit the preamble 101. For example, in some instances, the base station 120 may provide one or more of: a preamble format, a set of sequences to be used for the preamble, an expected preamble power to be received at the base station, a step size in case of failure, the association between synchronization signal and random access channel slots, and/or a window for a response from the base station. In a further implementation, the UE 110 may determine which random access channel slot to use based on the synchronization signal that it decoded

Once the UE 110 has determined which random access channel slot to use, a preamble sequence may be transmitted 101 by UE to access the base station 120 network. For example, the UE 110 may select a preamble format and a preamble sequence from the set provided by the base station 120 and transmits the preamble 101 in a transmission slot (e.g., a random-access channel (RACH) slot) based on the synchronization signal it decoded to synchronize with the network. Once the UE 110 has transmitted a random-access preamble 101. It waits for the random-access response 102 from the base station 120 that it has properly received the preamble. The random-access response 102 may be transmitted as a conventional downlink (e.g., a PDCCH/PDSCH transmission).

In some implementations, the random-access response 102 may include one or more of: information about the random-access preamble sequence the network detected and for which the response is valid, a timing correction calculated by the network based on the preamble receive timing, a scheduling grant, indicating resources the device will use for the transmission of the subsequent MSG3 103 on uplink, and temporary identity, a Temporary Cell Radio Network Temporary Identifier (TC-RNTI), used for further communication between the UE 110 and the base station 120.

Thus, once the random-access response 102 has been received and analyzed by the UE 110, the UE responds with the acknowledgement of the RAR 103. More specifically, in some implementations, the UE may transmit MSG3 using a UL grant provided in random-access response. Generally, at the minimum, MSG3 should contain a UE identification. As discussed herein, the base station 120, may be a base station in a Stand Alone (SA) or a Not Stand Alone (NSA) network. The UE may have previously received, from the base station, an identification of the type of network, NSA or SA. Additionally, in a scenario where the base station 120 is in a SA network, MSG3 103 may contain a UE identification (e.g., a Serving Temporary Mobile Subscriber Identity (S-TMSI)) and contains a request for Radio Resource Control (RRC) connection setup. Alternatively, if the base station 120 is in an NSA network, MSG3 103 may contain a UE identification (e.g., a Cell Radio Network Temporary Identifier (CRNTI)) that was provided by the master node (not shown).

In some implementations, the system requires the sending of a fourth message (e.g., MSG4). In general, the content of MSG4 may depend on the content of MSG3. For example, when the base station 120 is a SA base station, MSG4 may contain a response to a response to Radio Resource Control (RRC) connection request. Furthermore, in the case of contention based random access, MSG4 may contain a Contention Resolution Identity. The base station 120 (e.g., the network) considers the initial access process completed upon reception of MSG3, however, in the case of contention, the initial access completion happens after contention resolution (e.g., after MSG4 or later).

### System Improvements

As discussed herein, most preambles fail in completing Initial Access. These failures can be for various reasons, such as, for example: (1) it was fake preamble (e.g., no UE sent any preamble, but rather the base station decoded noise in the system as a possible preamble; (2) the UE fails to receive MSG2 102 successfully; or (3) the base station fails to receive MSG3 successfully. Regardless of the reason, precious downlink (e.g., for MSG2) and uplink (e.g., for MSG3) resources are wasted. Thus, if the bases station (e.g., network) can determine based on the received preamble 101 whether it would succeed in Initial Access or not, resources would be conserved by not responding to UE.

Thus, the systems and methods disclosed herein propose the use of a function (e.g., algorithm) that uses characteristics and/or parameters of a received preamble to predict the probability of successful reception of MSG3, assuming the base station responds to MSG1 101 with Message2 102. If the model predicts that the probability of a successful initial access is low, the base station may not send MSG2 (i.e., the Random-Access Response) 102 in response to the received MSG1 101 thus saving precious downlink/uplink resources.

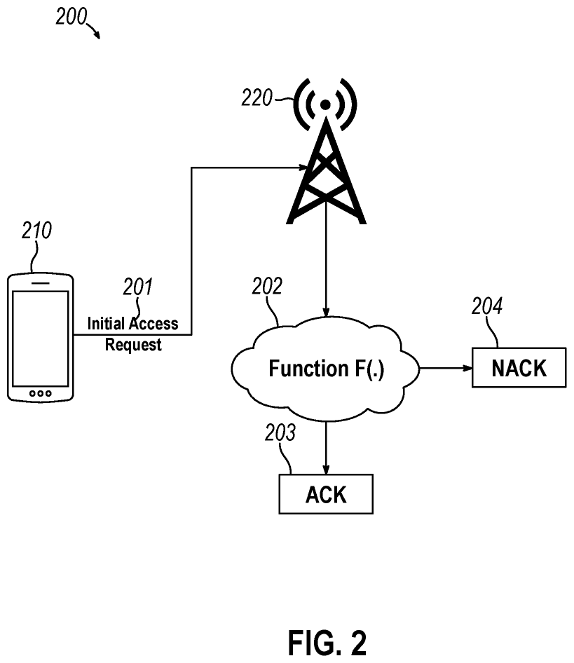

Referring now to FIG. 2, in one implementation, a system 200 may include one or more user equipment (UE) 210 devices that send an initial access preamble 201 to a radio receiver 220 that handles the initial request, scheduling, etc., as discussed herein. The received preamble characteristics may then be fed into a function F(⋅) 202 that can calculate the likelihood of whether the request would end up as acknowledged (ACK) 203 or not acknowledged (NACK) 204. The radio receiver then decides on whether to respond to the initial access request based on the likelihood values.

In some implementations, the function F(⋅) may be generated by a machine learning (ML) process, such as, for example, supervised learning, reinforcement learning, and/or unsupervised learning. In an implementation where supervised learning is used, the process may be performed offline (e.g., by collecting initial access logs from the radio receiver and learning the function from these logs). Alternatively, in some implementations, this process may be performed online using the radio network processor, which may result in a continuous refining of the function (e.g., by performing online training whenever an initial access attempt is performed).

It should further be understood that supervised learning may be done in various ways, such as, for example, using random forests, support vector machines, neural networks, and the like. By way of non-limiting example, any of the following types of neural networks that may be utilized, including, deep neural networks (DNNs), convolutional neural networks (CNNs), and recurrent neural networks (RNNs), or any other known or future neural network that satisfies the needs of the system. In an implementation using supervised learning the neural networks may be easily integrated into the hardware (e.g., in the form of simple vector-matrix multiplications).

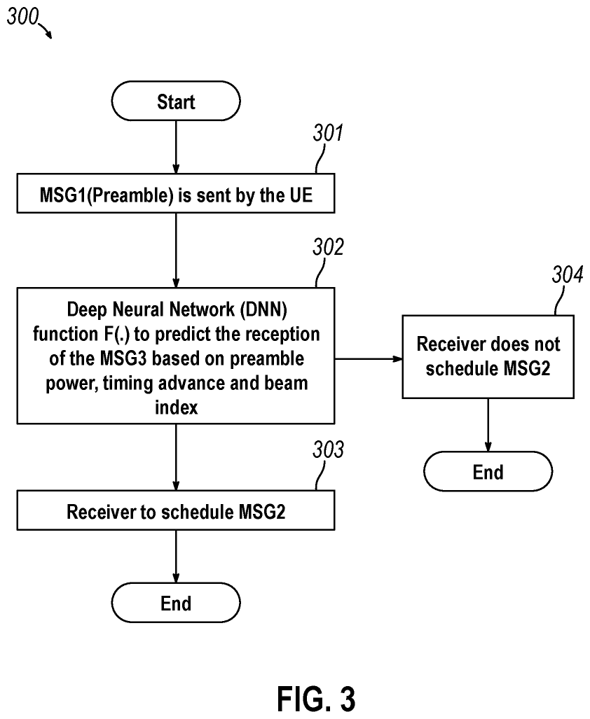

Referring now to FIG. 3, an illustrative flow chart is shown representing when a neural network (e.g., DNN) is used as function F(⋅). Specifically, in some implementations, the systems or methods disclosed herein may begin when the UE sends preamble (e.g., MSG1) 301 to the network (e.g., via a base station 120/220). The neural network may then predict the reception of initial access response 302, based on the preamble characteristics (e.g., MSG1 in 3^{rd} Generation Partnership Project (3gpp) standards). Based on this prediction, the receiver decides whether or not to schedule an initial access response (e.g., MSG2 in 3gpp standards, for the initial access request.) Thus, in some implementations, the neural network may predict a high likelihood of reception of an initial access response and schedule the sending of MSG2 303. Alternatively, in some implementations, the neural network may predict a low likelihood of reception of an initial access response and thus not schedule the sending of MSG2 304

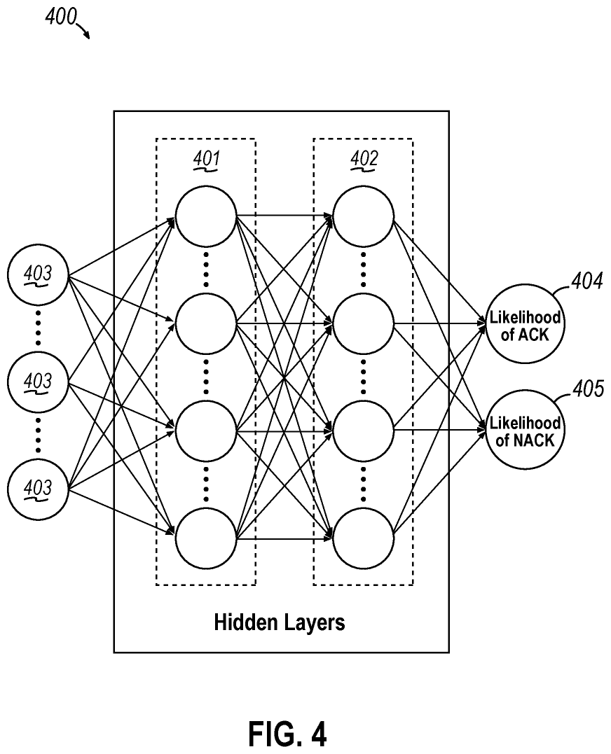

Referring now to FIG. 4, an example neural network (e.g., DNN) is shown 400. In some implementations, and as shown, the neural network 400 may include two hidden layers represented by dashed boxes 401 and 402. In one implementation, the features 403 that are extracted from the preamble (e.g., preamble characteristics) may be fed into the neural network 400. Next, the features 403 may go through a set of hidden layers (e.g., 401 and/or 402). Once the features 403 pass though the hidden layers 401 and/or 402, they may be output (e.g., as an output layer) the likelihoods of ACK 404 or NACK 405.

### Neural Network Training

As should be understood by one of ordinary skill in the art, in order for the neural network (NN) 400 to output a proper analysis, it must be trained properly (e.g., with an enormous collection of samples) to accurately extract the likelihood values. If not trained properly, overfitting (e.g., when the NN memorizes the structure of the preambles but is unable to generalize to unseen preamble characteristics) or underfitting (e.g., when the NN is unable to learn a proper function even on the data that it was trained on) may happen. Thus, implementations may exist that prevent overfitting or underfitting, involving a set of well-engineered features that must be extracted from the preamble characteristics.

By way of non-limiting example, a case for a collection of N initial access logs may utilize Equation 1:

$$L = [ \begin{matrix}{Ta}_{i} & … & {Ta}_{N} \\ {P}_{i} & … & {P}_{N} \\ {B}_{i} & … & {B}_{N}\end{matrix} ] , \qquad Equation 1$$

where Taₜ is the timing advance in units of clock cycles, Pᵢ is the received preamble power in units of dBm, Bᵢ is the integer-valued beam index for sample index i. Continuing with the non-limiting example, a case for an engineered set of features fᵢ∈R¹⁴ is as follows in Equation 2:

$${f}_{i} = {[ v e c ( {L}_{i} {L}_{i}^{T} ) {( correlate ( {L}_{i} , {L}_{i} ) )}^{T} ]}^{T} \qquad Equation 2$$

where vec(⋅) is the column-wise vectorization function, correlate(⋅) is the instantaneous autocorrelation function, and Lᵢ∈R³ is the Ah column of the matrix L. Thus, in this example, the outer product

$${L}_{i} {L}_{i}^{T}$$

and the autocorrelation ensure that all the cross-combinations of the collected logs are generated for NN training.

Thus, returning to FIG. 4, an example NN (e.g., a DNN) is shown having two hidden layers 401 and 402, with an output layer 404 and 405. In some implementations, each layer j (e.g., 401 and 402) may have its own weight (e.g., Wⱼ∈R^{z×q}) as well as its own biases (e.g., b∈R^{q}) where z is the number of inputs and q is the number of outputs (e.g., the number of neurons). Using these individual weights and biases, the input/output relationship of a layer can be expressed as Equation 3:

$${o}_{j} = {σ}_{j} ( {W}_{j} \times {x}_{j} + {b}_{j} ) , \qquad Equation 3$$

Where σⱼ(⋅) is the activation function of the layer j, which is usually a non-linear function. In a further implementation, the activation function for one or more of the hidden layers may utilize a rectified linear input that expressed as Equation 4:

$$R e L U ( x ) = \{ \begin{matrix}x , x > 0 \\ 0 , x \leq 0\end{matrix} . \qquad Equation 4$$

In another implementation, the activation function may utilize a SoftMax function expressed as Equation 5:

$$softmax ( {x}_{i} ) = \frac{{x}_{i}}{{\sum }_{c = 1}^{C} {e}^{{x}_{c}}} , \qquad Equation 5$$

Where C is the number of outcomes (i.e., the number of classes for a supervised classification task). Finally, in some embodiments, the overall input-output relationship for the neural network (NN) (e.g., DNN) may be expressed as Equation 6:

$${\hat{y}}_{i} = softmax ( {W}_{3} ( R e LU ( {W}_{2} \times ( ReL U ( {W}_{1} \times {f}_{i} + {b}_{1} ) + {b}_{2} ) + {b}_{3} ) ) , ( 1 ) \qquad Equation 6$$

Where y is the output of the NN for the set of features fᵢ given as the input.

Accordingly, as discussed herein, the preamble (i.e., MSG1) contains various data points, which are stored in matrix L shown in Equation 1. In some implementations, the corresponding acknowledgement of the random-access response (i.e., MSG3) may be stored in Y=[y₁ . . . , y_{N}], where each yᵢ is a one hot-encoded vector such that

$${y}_{i} ∈ {\{ 0 , 1 \}}^{C} , {\sum }_{j}^{C} {y}_{i}^{j} = 1.$$

In a further implementation, the weights and the biases described herein may be calculated by minimizing the cross-entropy loss between the NN output and the ground truth labels represented as Equation 7:

$$argmi {\sum }_{i}^{N} - {\sum }_{j}^{C} {y}_{i}^{j} * log ( {\hat{y}}_{i}^{j} ) , \qquad Equation 7$$

Where set [symbol] contains weights and biases for all layers (e.g., 401, 402, etc.). In some implementations, this optimization problem may not have a closed-form solution and thus, the weights and biases may be calculated by using a Stochastic Gradient Descent (SGD).

Once the weights and biases are calculated, an implementation may feed in the features generated from the initial access request data into Equation 1 to calculate the likelihood of random-access response acknowledgement.

### Example Use-Case Using Artificial Neural Networks

An illustrative example implementation is discussed below to help understand the complexity of the systems and methods disclosed herein. It should be understood that the processes, calculations, results, etc., discussed below are for illustrative purposes only and alternative implementations may exist. An example test to evaluate the efficacy of the method using a single layer neural network, called Artificial Neural Network (ANN). In this example, it was observed that one hidden layer solution performs equally well as the two-layer DNN described above. Thus, due to the faster training times, a one hidden layer solution is used for this exemplary case. However, as noted above, for other cases, deeper neural networks may perform better.

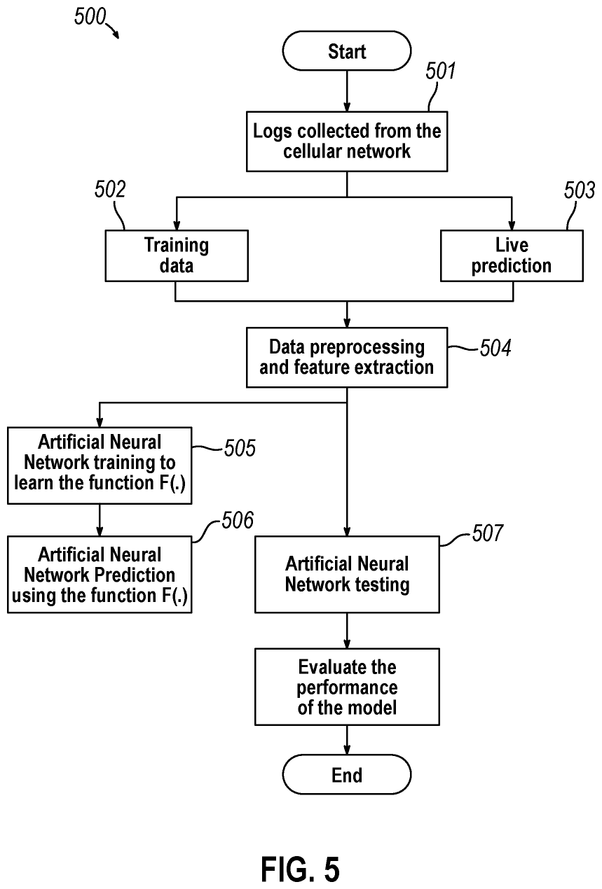

Referring now to FIG. 5, an example flow diagram 500 illustrating the steps taken for this example case using the artificial neural networks (ANNs). Thus, in some implementations, and as shown, the initial access logs may be collected from two separate real-life cells 501. Once collected, the logs may be separated into training data 502 and testing data 503. Next, features may be extracted and/or generated 504 for the training and test data. The NN (e.g., ANN) may then be trained 505 using the features, and the ACK and NACK labels within the training data. Once trained, the NN (e.g., ANN) can perform live prediction 506 based on the training process 505. Finally, the NN is tested 507 using the separated test data by comparing the predicted ACK/NACK labels and ground-truth labels in the dataset. The performance of the NN was then evaluated 508 to determine its effectiveness. Table 1, shown below represents the characteristics of the logs collected.

TABLE 1
Details of Collected Logs

| Cell | Technology | Cell type | Duration | Number of samples |
|---|---|---|---|---|
| A | 5G NR FR2 | Street macro | 6 days | 31001 |
| B | 5G NR FR2 | Indoor | 6 days | 24296 |

In another illustrative example, a one hidden-layer feed-forward neural network (i.e., an artificial neural network (ANN)), with 10 ReLU activations on its hidden layer, and 2 SoftMax activations on its output layer are used. In this example case, a cell-specific solution was used, (i.e., for each network, a separate ANN is trained and used for predicting the corresponding likelihood values). In this example, the collected logs for each cell, are randomly divided into two subsets, such that: 70% of the logs are used for training the NN, and the remaining 30% of the logs are used for testing the efficacy of the network.

### Example Results

Discussed below are hypothetical example results for an implementation disclosed herein. Because the SoftMax output values of the NN falls between zero and one; and because the ground-truth labels are either zero (i.e., NACK) or one (i.e., ACK), a quantization operation is needed to calculate the accuracy of the NN. The accuracy is defined by Equation 8:

$$accuracy = 1 - \frac{{\sum }_{i = 1}^{N} \vert Q ( {\hat{y}}_{i} , t ) - {y}_{i} \vert}{N} , \qquad Equation 8$$

Where,

$$Q ( x , t ) = \{ \begin{matrix}1 , x > t \\ 0 , x \leq t\end{matrix} ,$$

is the quantization function. In addition to accuracy, the following metrics may be used to evaluate the performance:
a. True positive rate (TPR): The ratio of correctly classified labels among all the positive (ACK) labels defined as

$$TPR = \frac{T P}{P} ,$$

where TP is the number of correctly classified positive labels, and P is the total number of positive labels in the data.
b. True negative rate (TNR): The ratio of correctly classified labels among all the negative (NACK) labels defined as

$$TNR = \frac{T N}{N} ,$$

where TN is the number of correctly classified negative labels, and N is the total number of negative labels in the data.
c. False positive rate (FPR): The ratio of incorrectly classified negative labels among all the negative (NACK) labels defined as

$$F P R = \frac{F P}{N} ,$$

where FP is the number of incorrectly classified negative labels, and N is the total number of negative labels in the data.
d. False negative rate (FNR): The ratio of incorrectly classified positive labels among all the positive (ACK) labels defined as

$$FNR = \frac{F N}{P} ,$$

where FN is the number of incorrectly classified positive labels, and P is the total number of positive labels in the data.

All these metrics may be put in a 2×2 matrix, generally referred to as a confusion matrix and it is defined by Equation 9:

$$Confusion matrix = [ \begin{matrix}TPR & FNR \\ FPR & TNR\end{matrix} ] \qquad Equation 9$$

Because the FNR represents the amount of performance degradation during scheduling (e.g., the initial access request will be ignored even though it would end up as ACK) minimizing its value is a primary focus. Alternatively, effort should be made to maximize the TNR because it represents the amount of savings in scheduling resources (e.g., an initial attempt was ignored because it would end up as NACK). Thus, these two parameters are usually negatively correlated (e.g., one can compromise from FNR to achieve a higher TNR rate). For this reason, the TNR is calculated at 3% and 5% FNR in the next example.

Tables 2a-c, shown below, represent a confusion matrix for Cell A using: (a) a single MSG1 characteristic, (b) two MSG1 characteristics, and (c) three Messsage1 characteristics, respectively.

TABLE 2a
Confusion matrix for cell A using only preamble
power, or timing advance, or beam index.

| Preamble Power | | Timing Advance | | Beam Index | |
|---|---|---|---|---|---|
| TNR-0.99 | FNR-0.09 | TNR-0.88 | FNR-0.7 | TNR-0 | FNR-0 |
| FPR-0.01 | TPR-0.99 | FPR-0.12 | TPR-0.83 | FPR-1 | TPR-1 |

| | | |
|---|---|---|
| Accuracy: 92.61% | Accuracy: 84.15% | Accuracy: 72.06% |

TABLE 2b
Confusion matrix for cell A using only preamble
power and timing advance, or preamble power and
beam index, or beam index and timing advance:

| Preamble Power, | | Preamble Power, | | Beam Index, | |
|---|---|---|---|---|---|
| Timing Advance | | Beam Index | | Timing Advance | |
| TNR-0.92 | FNR-0.06 | TNR-0.99 | FNR-0.1 | TNR-0.86 | FNR-0.87 |
| FPR-0.077 | TPR-0.94 | FPR-0.009 | TPR-0.9 | FPR-0.014 | TPR-0.91 |

| | | |
|---|---|---|
| Accuracy: 93.21% | Accuracy: 92.50% | Accuracy: 89.81% |

TABLE 2c
Confusion matrix for cell A using
preamble power, timing advance, and beam index:
Preamble Power, Timing Advance, Beam Index

| | |
|---|---|
| TNR-0.93 | FNR-0.04 |
| FPR-0.07 | TPR-0.96 |

Accuracy: 94.75%

Tables 3a-c, shown below, represent the same confusion matrices as above, except that they are for cell B, instead of cell A. All the matrices are calculated for a threshold value t=0.5.

TABLE 3a
Confusion matrix for cell B using only preamble
power, or timing advance, or beam index

| Preamble Power | | Timing Advance | | Beam Index | |
|---|---|---|---|---|---|
| TNR-0.98 | FNR-0.065 | TNR-0.94 | FNR-0.11 | TNR-0 | FNR-0 |
| FPR-0.02 | TPR-0.94 | FPR-0.056 | TPR-0.89 | FPR-1 | TPR-1 |

| | | |
|---|---|---|
| Accuracy: 94.53% | Accuracy: 90.12% | Accuracy: 77.82% |

TABLE 3b
Confusion matrix for cell B using only preamble power and timing advance,
or preamble power and beam index, or beam index and timing advance:

| Preamble Power, | | Preamble Power, | | Beam Index, | |
|---|---|---|---|---|---|
| Timing Advance | | Beam Index | | Timing Advance | |
| TNR-0.97 | FNR-0.025 | TNR-0.96 | FNR-0.047 | TNR-0.86 | FNR-0.87 |
| FPR-0.03 | TPR-0.97 | FPR-0.044 | TPR-0.95 | FPR-0.14 | TPR-0.91 |

| | | |
|---|---|---|
| Accuracy: 97.28% | Accuracy: 95.35% | Accuracy: 90.05% |

TABLE 3c
Confusion matrix for cell B using
preamble power, timing advance, and beam index:
Preamble Power, Timing Advance, Beam Index

| | |
|---|---|
| TNR-0.95 | FNR-0.02 |
| FPR-0.05 | TPR-0.98 |

Accuracy: 97.56%

As shown in Tables 2c and 3c, compared to other combinations, using all the MSG1 characteristics always yielded a higher accuracy than using two MSG1 characteristics or using a single MSG1 characteristic. Thus, by utilizing all three Messsage1 characteristics, one can achieve 93% reduction in scheduling resources while having only 4% performance degradation for cell A. Similarly, by including a simple threshold value (e.g., t=0.5) one can achieve 95% reduction in scheduling resources while having only 2% performance degradation for cell B.

Table 4, shown below, represents the TNR values for both cells (i.e., cell A and cell B) when the FNR is 0.03 and 0.05 using combinations of the three MSG1 characteristics for cell A and cell B. For the same FNR values, the NN trained for Cell B yields higher TNR values. This can be due to differences in cell locations, users, and the environmental differences. However, in some implementations, these differences may be minimized by training more complex NN structures, obtaining more logs for NN training, or using other means of (including but not limited to) ML (Machine Learning) algorithms as the function.

TABLE 4
TNR values for Cell A and Cell B for 0.03 and 0.0.5 FNR values.

| | | |
|---|---|---|
| Features | TNR at FNR = 0.03 | TNR at FNR = 0.05 |

CELL A

| | | |
|---|---|---|
| Preamble Power | 0.47 | 0.69 |
| Timing Advance | 0.29 | 0.37 |
| Beam Index | 0 | 0.21 |
| Preamble Power, Timing | 0.85 | 0.9 |
| Advance | | |
| Preamble Power, Beam | 0.76 | 0.84 |
| Index | | |
| Beam Index, Timing | 0.48 | 0.77 |
| Advance | | |
| Preamble Power, Timing | 0.91 | 0.94 |
| Advance, Beam Index | | |

CELL B

| | | |
|---|---|---|
| Preamble Power | 0.81 | 0.96 |
| Timing Advance | 0.43 | 0.68 |
| Beam Index | 0 | 0.23 |
| Preamble Power, Timing | 0.973 | 0.986 |
| Advance | | |
| Preamble Power, Beam | 0.84 | 0.96 |
| Index | | |
| Beam Index, Timing | 0.36 | 0.56 |
| Advance | | |
| Preamble Power, Timing | 0.974 | 0.988 |
| Advance, Beam Index | | |

### Additional Implementations

As described above, the present disclosure includes systems and methods for generating a function that maps characteristics (e.g., timing advance, beam index, and preamble power) of an initial access preamble (e.g., MSG1) to the probability of acknowledgment or non-acknowledgement of reception of RAR (e.g., ACK or NACK). Generating this function consists of performing a supervised learning process to learn the acknowledge reception of RAR from the features extracted from timing advance, beam index, and preamble power. Once this learning process is completed, the function parameters can be used to predict the likelihood of successfully decoding MSG3, and thus, the cellular network can decide whether to schedule MSG2 for a given random access request. Several additional possible scenarios are given below.

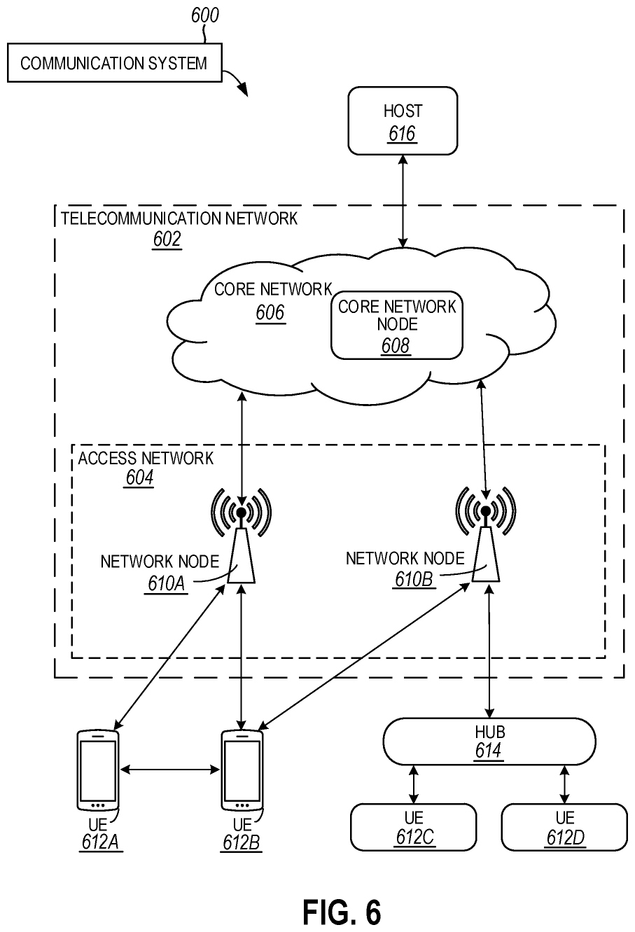

FIG. 6 shows an example of a communication system 600 in accordance with some embodiments. In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3rd Generation Partnership Project (3GPP) access node or non-3GPP access point. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 602 includes one or more Open-RAN (ORAN) network nodes. An ORAN network node is a node in the telecommunication network QQ 102 that supports an ORAN specification (e.g., a specification published by the O-RAN Alliance, or any similar organization) and may operate alone or together with other nodes to implement one or more functionalities of any node in the telecommunication network 602, including one or more network nodes 610 and/or core network nodes 608.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof. For example, the AI models and/or ML models described herein for predicting success or failure of initial access attempts may be implemented using rApps in an ORAN compliant RAN intelligent controller. The network node may support a specification by, for example, supporting an interface defined by the ORAN specification, such as an A1, F1, W1, E1, E2, X2, Xn interface, an open fronthaul user plane interface, or an open fronthaul management plane interface.

Moreover, an ORAN access node may be a logical node in a physical node. Furthermore, an ORAN network node may be implemented in a virtualization environment (described further below with reference to FIG. 10) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network node (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602 and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

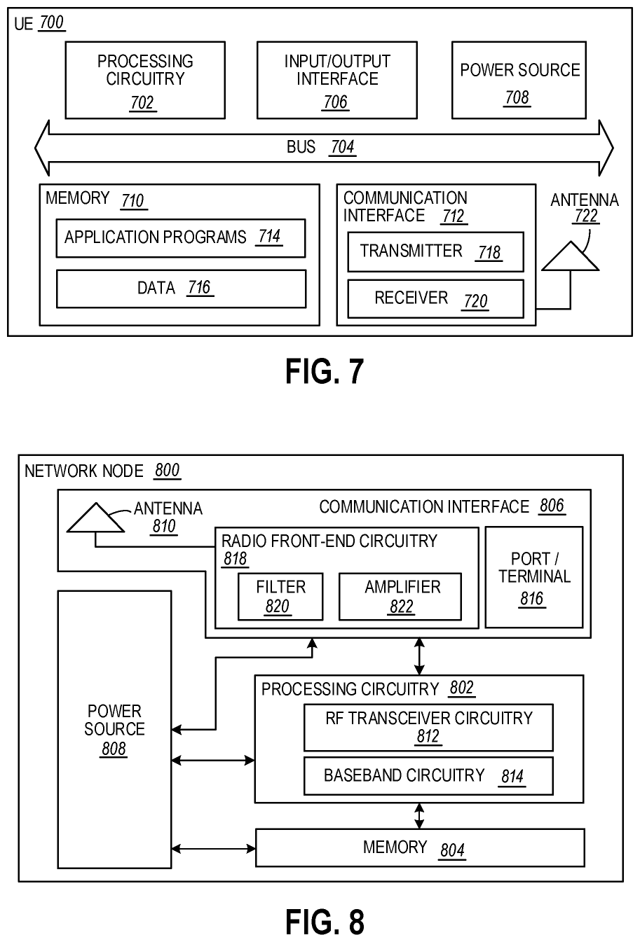

FIG. 7 shows a UE 700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random-access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

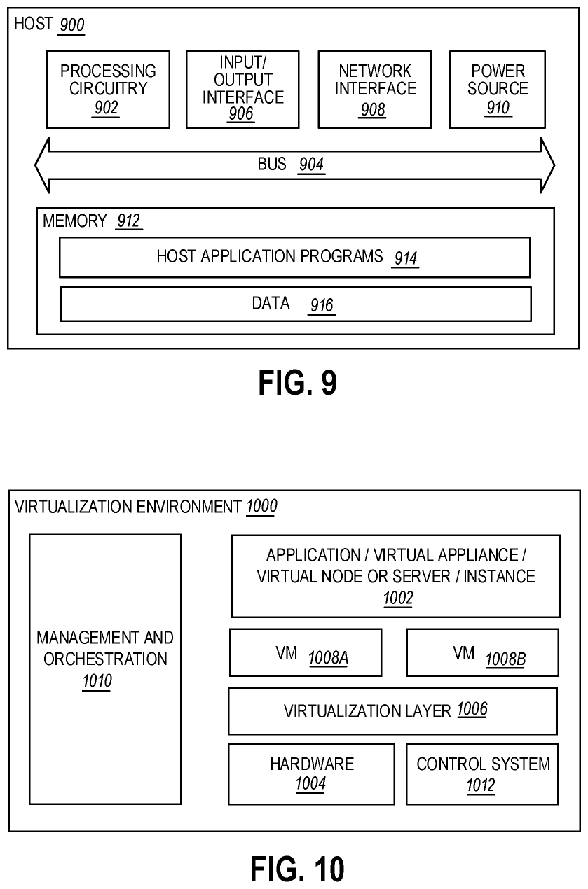

FIG. 9 is a block diagram of a host 900, which may be an embodiment of the host 616 of FIG. 6, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g., such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

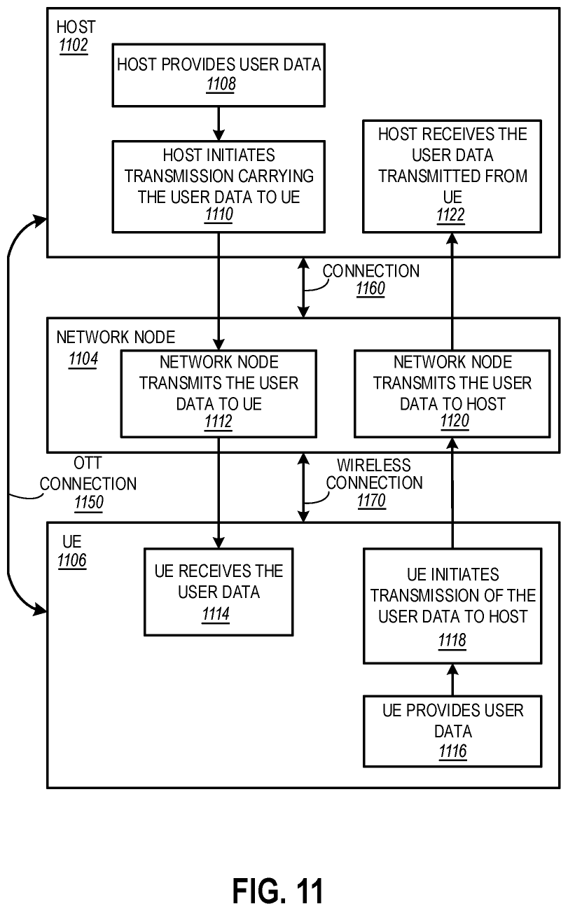

FIG. 11 shows a communication diagram of a host 1102 communicating via a network node 1104 with a UE 1106 over a partially wireless connection in accordance with some embodiments. Example implementations, in accordance with various embodiments, of the UE (such as a UE 612a of FIG. 6 and/or UE 700 of FIG. 7), network node (such as network node 610a of FIG. 6 and/or network node 800 of FIG. 8), and host (such as host 616 of FIG. 6 and/or host 900 of FIG. 9) discussed in the preceding paragraphs will now be described with reference to FIG. 11.

Like host 900, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1111, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the data rate, latency, and/or power consumption and thereby provide benefits such as reduced user waiting time, relaxed restriction on file size, improved content resolution, better responsiveness, and/ay have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors (not shown) may be deployed in or in association with other devices through which the OTT connection 1150 passes; the sensors may participate in the measurement procedure by supplying values of the monitored quantities exemplified above or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

### Computer Systems of the Present Disclosure

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The memory may take any form and may depend on the nature and form of the computing system. The memory can be physical system memory, which includes volatile memory, non-volatile memory, or some combination of the two. The term “memory” may also be used herein to refer to non-volatile mass storage such as physical storage media.

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof.

For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The term “executable component” is also well understood by one of ordinary skill as including structures that are implemented exclusively or near-exclusively in hardware logic components, such as within a field programmable gate array (FPGA), an application specific integrated circuit (ASIC), Program-specific Standard Products (ASSPs), System-on-a-chip systems (SOCs), Complex Programmable Logic Devices (CPLDs), or any other specialized circuit. Accordingly, the term “executable component” is a term for a structure that is well understood by those of ordinary skill in the art of computing, whether implemented in software, hardware, or a combination thereof.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In an embodiment, the communication system may include a complex of computing devices executing any of the method of the embodiments as described above and data storage devices which could be server parks and data centers.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

Accordingly, embodiments described herein may comprise or utilize a special purpose or general-purpose computing system. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example—not limitation—embodiments disclosed or envisioned herein can comprise at least two distinctly different kinds of computer-readable media: storage media and transmission media.

Computer-readable storage media include RAM, ROM, EEPROM, solid state drives (“SSDs”), flash memory, phase-change memory (“PCM”), CD-ROM or other optical disk storage, magnetic disk storage or other magnetic storage devices, or any other physical and tangible storage medium that can be used to store desired program code in the form of computer-executable instructions or data structures and that can be accessed and executed by a general purpose or special purpose computing system to implement the disclosed functionality or functionalities. For example, computer-executable instructions may be embodied on one or more computer-readable storage media to form a computer program product.

Transmission media can include a network and/or data links that can be used to carry desired program code in the form of computer-executable instructions or data structures and that can be accessed and executed by a general purpose or special purpose computing system. Combinations of the above should also be included within the scope of computer-readable media.

Further, upon reaching various computing system components, program code in the form of computer-executable instructions or data structures can be transferred automatically from transmission media to storage media (or vice versa). For example, computer-executable instructions or data structures received over a network or data link can be buffered in RAM within a network interface module (e.g., a “NIC”) and then eventually transferred to computing system RAM and/or to less volatile storage media at a computing system. Thus, it should be understood that storage media can be included in computing system components that also—or even primarily—utilize transmission media.

Those skilled in the art will further appreciate that a computing system may also contain communication channels that allow the computing system to communicate with other computing systems over, for example, a network. Accordingly, the methods described herein may be practiced in network computing environments with many types of computing systems and computing system configurations. The disclosed methods may also be practiced in distributed system environments where local and/or remote computing systems, which are linked through a network (either by wired data links, wireless data links, or by a combination of wired and wireless data links), both perform tasks. In a distributed system environment, the processing, memory, and/or storage capability may be distributed as well.

Those skilled in the art will also appreciate that the disclosed methods may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by preferred embodiments, exemplary embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

All references cited in this application are hereby incorporated in their entireties by reference to the extent that they are not inconsistent with the disclosure in this application. It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be affected to the particular embodiments by those of skill in the art without departing from the scope of the description, which is defined solely by the appended claims.

1. A method performed by a user equipment, UE, for performing an initial access procedure, the method comprising:
sending, by the UE, a first message comprising a preamble to a network node, wherein the preamble has at least one characteristic that is used by the network node to estimate, using an Artificial Intelligence, AI, model, a probability that a third message will be received from the UE,
receiving a second message from the network node if the probability exceeds a minimum threshold; and
sending the first message a second time if the probability does not exceed the minimum threshold.

2. The method of claim 1, further comprising sending the third message to the network node.

3. The method of claim 1, further comprising:
providing user data; and
forwarding the user data to a host via transmission to the network node after completing the initial access procedure.

4. A method performed by a network node for performing an initial access procedure, the method comprising:
receiving, from a user equipment, UE, a first message comprising a preamble;
estimating, using an Artificial Intelligence, AI, model, a probability that a third message will be received from the UE based on the preamble; and
responsive to estimating the probability exceeds a minimum threshold, transmitting, to the UE, a second message.

5. The method of claim 4, wherein the AI model comprises a machine learning, ML, model.

6. The method of claim 4, further comprising identifying at least one characteristic associated with the preamble.

7. The method of claim 6, wherein estimating the probability further comprises calculating, using the AI model, a probability that the third message will be received form the UE based on the at least one characteristic.

8. The method of claim 6, wherein the at least one characteristic comprises one or more of: a timing advance characteristic, a beam index characteristic, a preamble power characteristic, a portion of the first message, a measurement related to the first message.

9. The method of claim 4, wherein estimating the probability further comprises determining that the preamble is a fake preamble.

10. The method of claim 4, further comprising prior to receiving the first message, transmitting, to the UE, system information.

11. The method of claim 10, wherein receiving the first message further comprises receiving the first message via a specific transmission slot, wherein the transmission slot is determined based on the system information.

12. (canceled)

13. The method of claim 4, further comprising determining, based on the preamble, a random-access preamble sequence, wherein the second message comprises information associated with the random-access preamble sequence.

14. The method of claim 4, further comprising determining, based on the preamble, a timing correction, wherein the second message comprises information associated with the timing correction.

15. The method of claim 4, further comprising determining, based on the preamble, a scheduling grant, wherein the second message comprises information associated with the scheduling grant.

16. The method of claim 4, further comprising determining, based on the preamble, a temporary identify, wherein the second message comprises information associated with the temporary identity.

17. The method of claim 4, further comprising, receiving, from the UE, the third message.

18. (canceled)

19. (canceled)

20. The method of claim 17, further comprising transmitting, to the UE, a fourth message based on the third message.

21. The method of claim 20, wherein the fourth message comprises a Radio Resource Control, RRC, connection request or a contention resolution identity.

22-31. (canceled)

32. A network node for performing an initial access procedure, the network node comprising:
processing circuitry;
power supply circuitry configured to supply power to the processing circuitry; and
memory, wherein the memory contains instructions that, when executed by the processing circuitry, cause the network node to:
receive, from a user equipment, UE, a first message comprising a preamble;
estimate, using an Artificial Intelligence, AI, model, a probability that a third message will be received from the UE based on the preamble; and
responsive to estimating the probability exceeds a minimum threshold, transmit, to the UE, a second message.

33. A UE for performing an initial access procedure, the UE comprising:
an antenna configured to send and receive wireless signals;
radio front-end circuitry connected to the antenna and to processing circuitry, and configured to condition signals communicated between the antenna and the processing circuitry;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE; and
memory, wherein the memory contains instructions that, when executed by the processing circuitry, cause the UE to:
send a first message comprising a preamble to a network node, wherein the preamble has at least one characteristic that is used by the network node to estimate, using an Artificial Intelligence, AI, model, a probability that a third message will be received from the UE,
receive a second message from the network node if the probability exceeds a minimum threshold; and
send the first message a second time if the probability does not exceed the minimum threshold.

34-44. (canceled)
